(19) United States
(12) Patent Application Publication
(10) Pub. No.: US 2018/0251223 A1
(43) Pub. Date: Sep. 6, 2018

(54) TAILED PARACHUTE-PARAGLIDER

(71) Applicant: Dario Enea TUMAZZO, Milano (IT)

(72) Inventor: Dario Enea TUMAZZO, Milano (IT)

(21) Appl. No.: 15/758,687

(22) PCT Filed: Dec. 17, 2015
(86) PCT No.: PCT/IB2015/059729

§ 371 Date: Mar. 8, 2018

(30) Foreign Application Priority Data
Sep. 15, 2015 (CH) 01335/15

(51) Int. Cl. B64D 17/02

(52) U.S. Cl. CPC B64D 17/025

(57) ABSTRACT

Tailed parachute-paraglider (10) comprising a first portion (A) of a substantially squared/rectangular shape with sides (11, 13) two by two substantially parallel and opposed, and a second portion (B) with trapezoidal shape, comprising a couple of opposite parallel sides with the longest side of said couple of opposite parallel sides jointed to a side of said first portion (A) and the smallest side of said couple of opposite parallel sides comprising wires suitable for being jointed to legs and/or feet of a user (100); said second portion (B) being rotatable substantially around a transverse axis (Y) orthogonal to a longitudinal plane (X-X) of said tailed parachute-paraglider (10), wherein said transverse axis is substantially coinciding with said longest side of said couple of opposite sides and with a side of said first portion (A).

### FIELD OF THE TECHNIQUE

The present invention concerns the devices of flight assistance and in detail concerns a tailed perfected parachute-paraglider.

### BACKGROUND ART

To the end of stopping chutes or performing sporting sailed flight activity, different types of parachute and paragliders are known.

The parachute is a device constructed with various types of fabrics or synthetic materials which is fastened to a human body or to an object by means of strops or ropes, and allows their controlled free fall. More technically, the parachute is an aerodynamic decelerator capable of slowing the descent to the ground, through an aerodynamic resistance in the atmospheric air fluid, that is much greater as greater is the surface of the sail that is a dome.

The directionality (when required) of the parachute is obtained by means of traction commands, that modifying the form or inclination of the sail, allow for influencing the deviation (for domed parachutes) or the gliding (for those with a wing).

In contrast, the paraglider, that is derived from parachute, has been principally conceived for amateur use, and not only like a safety means, and comprises an elongated sail.

Technically, the paraglider presents therefore a sail that is not rigid but wherein the form is kept by the internal pressure, which is dynamically created by the flow of the air on the front mouths of the wing.

Respective to parachute, the paraglider presents more complex commands capable of slowing or accelerating the horizontal speed of the means. In detail, in the bundle of ropes that is present as a sustain and control between the user and the paraglider itself, exist the rear bundle, connected to the outer edge, that is provided also with two handles (the brakes) and is used for controlling of the sail. A couple of frontal ropes act as accelerator, allows for modifying the incidence of the wing shortening in a differentiated way the various funicular lines, and is controlled by means of the feet of the user. In detail, decreasing the incidence of the wing speed is increased.

The applicant has considered that today said two devices are not interchangeable for the use for which they are conceived and, in addition, do not allow great active movements for the user. This means that said user “passively” accepts the sailed flight, without performing a real and actual physical exercise. In detail, the applicant has considered the absence of means that allow for a greater autonomy and duration of the flight and of control of the descent, so as to lengthen the amusement.

The scope of the present invention is therefore to realize a tailed perfected parachute-paraglider that allows for obtaining the safety performances of a parachute jointed with the practicality and recreational behaviour of a paraglider, but leaving the possibility of performing more physical exercise to the user, allowing for a greater flight autonomy and creating an autonomous means for moving in the air with also the control of the turn and altitude.

### SUMMARY OF THE INVENTION

According to the present invention is realized tailed perfected parachute-paraglider, characterized in that it comprises a first portion with section substantially squared/rectangular with sides two by two substantially opposed and parallel and a second portion with trapezoidal section, comprising a couple of opposite sides of which a first bigger side of said couple of opposite sides is jonited to a side of said first portion and a second smaller side of said couple of opposite sides comprising wires suitable for being jointed indirectly to legs and/or feet of a user; said second portion rotates substantially rigidly around an ideal axis orthogonal to a longitudinal plane of said tailed perfected parachute-paraglider, wherein the centre of gravity in “flat” situation is arranged in the first portion.

Advantageously, there are further four further radial axes for keeping the ascensional motion keeping.

Advantageously, said tailed perfected parachute-paraglider is characterized in that it comprises a reinforcement longitudinal beam, arranged in correspondence of a longitudinal axis of said tailed perfected parachute-paraglider, and wherein said longitudinal beam extends for the whole the parachute, starting from a front side of the first portion A up to the at the end (side 15c) of the second portion B. Preferably the longitudinal sustaining beam presents a thickness which is greater than the others, in the order of 25 cm, experimentally defined according to the used material.

Advantageously, said tailed perfected parachute-paraglider is characterized in that it presents a couple of inclined sides left and right of said second trapezoid portion inclined respective to said longitudinal axis of said tailed perfected parachute-paraglider, wherein in correspondence of said inclined sides left and right there are reinforcement plastic small beams as it is shown in FIG. 5.

Advantageously, said tailed perfected parachute-paraglider is characterized in that both the portions present a plurality of canopies and arched front sections.

Advantageously, said tailed perfected parachute-paraglider is characterized in that said point wherein lies said sustaining means represents a barycentric point of said tailed perfected parachute-paraglider, and wherein said barycentric point (218) moves also in accordance to said rotation of the second portion respective to the first portion.

Advantageously, said tailed perfected parachute-paraglider is characterized in that it comprises a plurality of radial bundles in plastic material of helping and sustaining of the sewing of said canopies.

Advantageously, said tailed perfected parachute-paraglider is characterized in that said second portion presents a plurality of transversal bundles in plastics extending substantially parallel or inclined respective to a longitudinal axis, being orientated in a direction either substantially longitudinal or inclined respective to the longitudinal axis, with ends directed respectively towards said bigger side and said smaller side. Said features are anyway shown in FIG. 5.

Advantageously, said tailed perfected parachute-paraglider is characterized in that the length of the cables of the flat area reduces with respect to the “classical” paraglider without losing flight stability.

### DESCRIPTION OF FIGURES

The invention will be hereinafter described in a preferred and non-limiting embodiment thereof with reference to the annexed figures in which:

FIG. 1 shows a top view of the tailed perfected parachute-paraglider which is object of the present invention;

FIG. 2 shows a side view of the perfected parachute-paraglider which is object of the present invention;

FIG. 3 shows a perspective view of the tailed perfected parachute-paraglider which is object of the present invention.

FIG. 4 shows a detail of the tailed perfected parachute-paraglider which is object of the present invention.

FIG. 5 shows a further embodiment of the tailed perfected parachute-paraglider which is object of the present invention.

### DETAILED DESCRIPTION OF THE INVENTION

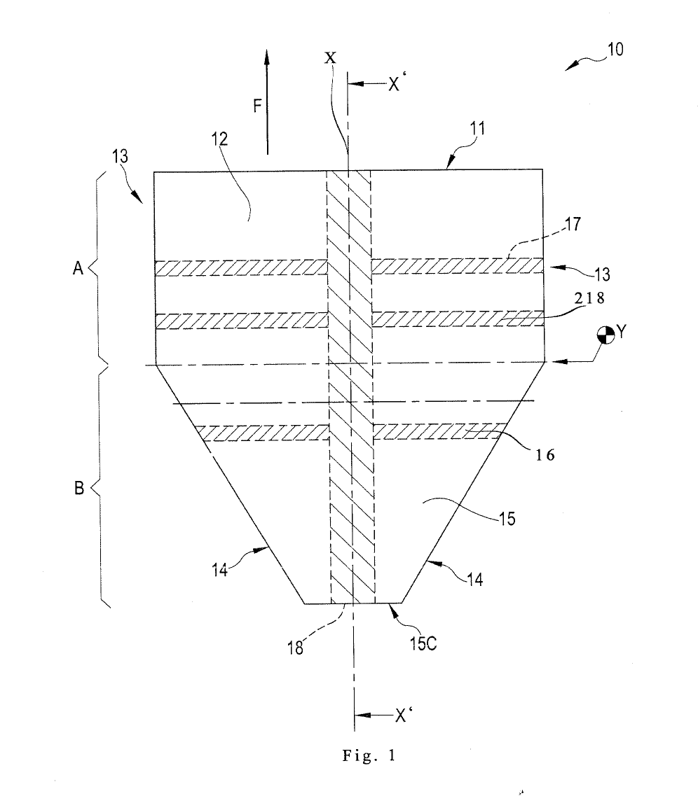

With reference to FIG. 1, with the reference number 10 is shown in its complex a tailed perfected parachute-paraglider.

The tailed perfected parachute-paraglider 10 which is object of the present invention configures itself as a device suitable for allowing to realize both the function of parachute, and therefore of substantially vertically descent, as the function of the paraglider and therefore a gliding and that can allow the increase of altitude.

The tailed perfected parachute-paraglider 10 which is object of the present invention, as shown in FIGS. 1-3, comprises a first portion A and a second portion B. Respective to a advancement direction F, represented by the homonymous arrow in FIG. 1, the first portion A is that that in use lies frontally and is therefore the front portion. The second portion B is that that in use lies behind the first portion A and is therefore la rear portion.

The first portion A presents a structure a section rectangular, preferably but in a non-limiting extent with an area comprised in 8 mq. In an exemplificative embodiment, said first portion A is 4 meters wide and 2 meters long.

As in the case of the perfected parachute, it is possible to perform a control of the turn by means of the handles moved by the hands (using the same system for the tail that is taken by the system of the acceleration bar of the paraglider—speed system). A part of the cables of portion A (for dx and sx sides) are connected to a jib connected for one end to the central part most closer to the head of the aluminium ring part of the “seat” and passing inside the oval for the other end to the hand.

In the prototype represented in FIG. 1 there are only radial bundles for reasons of representation easiness, even if in truth there are two further ones, for a total of five radial bundles (three in the portion A and two in the portion B).

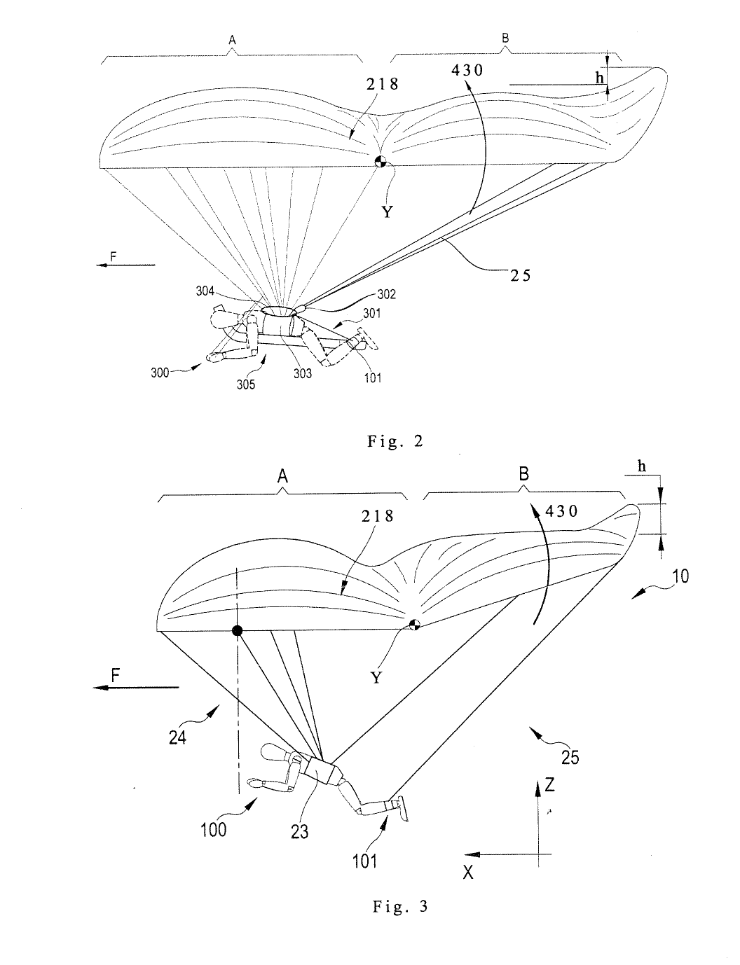

To this regard, according to the present invention for width is meant a size obtained on a side or front portion 11 that results in use to be perpendicular to a longitudinal axis X of the tailed perfected parachute-paraglider 10. On said longitudinal axis X lies also the longitudinal plane X-X. The tailed perfected parachute-paraglider 10 which is object of the present invention further comprises also a second portion B that is with a trapezoidal shape. In detail, said second portion B presents a couple of opposite sides and parallel of which a first side of said couple of opposite sides is jointed to a rear side of the first portion A and a second side 15c of said couple of opposite sides is instead positioned in the rear terminal position of the tailed perfected parachute-paraglider 10. In detail, between the first and the second portion A, B is therefore present an ideal axis Y, orthogonal respective to longitudinal plane X-X, around which (see arrow 430, FIG. 2) the second portion B rotates respective to the first portion A. In detail, said variation of the inclination on a longitudinal plane of the second portion B respective to the first portion A allows for variating the lift of the tailed perfected parachute-paraglider 10, and consequently the advancement speed of tailed perfected parachute-paraglider 10. Both the first and the second portion A, B present a respective clothed surface 12, 15 realized with a synthetic fabric of a known type and comprising a plurality of canopies 23A which are also present in the second portion B(23B), and orientated as known so as to have their principal axis parallel or substantially parallel to the longitudinal axis of the tailed perfected parachute-paraglider 10 and the radial sewing to the parachute-paraglider. Frontally, in correspondence of a front side 11 of the first portion A open a plurality of mouth 21 suitable for favouring the passage of the air and the lift of the tailed perfected parachute-paraglider 10.

In the rear part, in contrast, the second portion B presents a couple of left and right sides 14 respective to the longitudinal axis X, that therefore interconnect the two opposite bigger and smaller sides 15c. In an exemplificative and non-limiting embodiment, the length along the longitudinal axis of the second portion B is equal to 2.5 m and the smaller side 15c presents a width of 1 m. The applicant has observed that said sizes are those pre-established in the prototype for providing the effect of horizontal thrust along the direction F. Along the longitudinal plane X-X extends a longitudinal beam 18. Said longitudinal beam 18 is realized in plastic or aramid material that allows for an optimal resistance keeping the overall weight of the tailed perfected parachute-paraglider 10 as reduced as possible.

The longitudinal beam 18 extends for all both the first portion A and the second portion B. In FIG. 1 is anyway shown a longitudinal beam 18 that extends up to the rear portion B. Advantageously, but in a non-limiting extent, the tailed perfected parachute-paraglider 10 which is object of the present invention also comprises a radial bundle 16 of portion B in correspondence of one third of the height of the portion B starting from the bigger side of the second portion B.

Equivalently, preferably but in a non-limiting extent, also the first radial bundle 17 is present being arranged starting from half the first portion A, and is parallel to the last radial bundle 16 (in the second portion B), (both represent the limit-centers of gravity, that can never be reached and crossed).

In detail, observed that the first and the second section A, B are not planar but present an hemispheric or anyway recurved form. In a preferred and non-limiting embodiment of the present invention, the tailed perfected parachute-paraglider 10 is characterized in that preferably in correspondence of the inclined sides 14 there are small plastic reinforcement beams.

The effect of those small plastic reinforcement transversal beams as it is shown in FIG. 5, is to give more consistence to the structure and specifically to impede that the second portion B can sag excessively on the sides, rendering difficult also in use the control and stabilization of the tailed perfected parachute-paraglider 10.

Both to the first and the second portion A, B are connected with a known method a plurality supporting cables and wires. For what deals with the first portion A of the tailed perfected parachute-paraglider 10, the supporting cables 24 are so that when distended, a sustaining means 23 for the user 100 (for example a basket or an abdominal band, preferably in aluminium oval as the part of the harness for sustaining the user and the cables) lay in a point of the tailed perfected parachute-paraglider. Said point Y is the limit-point of the mobile part of the tailed perfected parachute-paraglider, since the second portion B can rotate around the ideal axis Y respective to the first portion A.

This means that having the first portion A whose left and right sides are 2 meters long, the barycentric point of the parachute-paraglider in a “flat” status will find itself in the first portion A (218), guaranting a considerably stability. The tailed perfected parachute-paraglider 10 further comprises wires of a known type for the folding of the extremity portions of the left and right sides 13 at half of the first portion A, that represent the portions of stabilization for the tailed perfected parachute-paraglider which is object of the present invention. Said wires are pushed downwards with the hands (with the same mechanism as the acceleration bar of the paraglider) allow advantageously for turning and incline the wings of the parachute-paraglider which is object of the present invention.

The wires 25 acts with the same mechanism but are actuated with the legs by means of known means for a their own first end on the smaller side 15c of the second portion B.

Said wires, on the opposite ends, could be conceived for being in use directly laced in correspondence of a lower portion of the legs of the user 100, for example and preferably in correspondence of the ankles, even if said configuration could appear less safe and effective. Through a downwards distension of said ankles, the portion B is pulled in its rear part downwards, causing during the advancement along the direction F, a motion or air flow downwards that increases the lift of the tailed perfected parachute-paraglider. In contrast releasing the legs upwards, the user 100 provides that also the portion B is left to unwind upwards and in detail this takes place as much as we move towards the rear portion of the same. So acting, the lift is reduced by the way increasing the advancement along the horizontal direction identified by the arrow F.

In a preferred and non-limiting embodiment of the present invention, further, there are a plurality of radial bundles in plastic material, of interconnection between the various canopies 23a, 23b that allow for reinforcing and sustaining specifically the sewing that are present between one canopy and the other.

Further, in the second portion B, also here there are transversal bundles in plastics, that extend substantially parallel or in a more inclined direction—outwardly—respective to the longitudinal axis of the tailed perfected parachute-paraglider herein described. Since those transversal bundles—that preferably are realized in more interconnected portions—are interconnected between the smaller side and the bigger side of said couple of sides of the second portion B, said transversal bundles are arranged radially, and as long as we move towards the inclined sides 14 of the second portion B, said transversal bundles become even more inclined respective to the longitudinal axis as it is shown in figure. The applicant has found that to the end of obtaining an optimal robustness of the second portion B impeding that this continuously flaps due to the action of the wind during the descent and due to the flow of the air which is often non-laminar in detail during the phases of rotation of the second portion B respective to the first portion A, the better results are obtained with a total of 10 transversal bundles, of which five on the left of the longitudinal axis and five on the right of the longitudinal axis. Said bundles are configured so as to join together on the bigger side and if this is 4 m long, at the distances of 175, 140, 105, 70, 35, from the centre (half) of said axis, with an indicative thickness of 8.75 cm (increasable up to 0.25 cm). Said proportion and the thickness are not to be considered as limiting, since the necessary number of transversal bundles decreases with their robustness and with the density of the sailing of the second portion B.

In the rear parte the sizes of said bundles are cm 25, 20, 25, 10 and 5 from the centre with the indicative thickness of 1.25 cm (increasable up to 0.25).

For what deals with the radial bundles, in contrast, the best performances are obtained having 5 radial bundles measuring them from the first side of portion A (11) of which the first is arranged at a distance comprised between 100 and 110 cm, the second between 129 and 139 cm, the third between 168 and 178 cm, the fourth between 227 and 237 cm, the fifth between 270 and 283 cm per part. Said radial bundles are three in portion A and two in portion B.

The applicant has found that the textile material with which the sailings of the first and second portion A, B are made is preferably a synthetic material with 40 g/m2, for example Dyneema or aramid fibre, for letting that the tailed perfected parachute-paraglider 10 which is object of the present invention can have an on-flight weight in the order between 45 and 105 kg. The applicant has further observed that with the tailed perfected parachute-paraglider which is object of the present invention, the load on the wing with a normal user 100 is comprised between 5.6-13.1 kg/m2.

In a further preferred and non-limiting embodiment of the tailed perfected parachute-paraglider 10 which is object of the present invention, there is a braking bar 300 technically known with the term of speed bar in the case of the traditional paragliders. Said braking bar is interconnected both on the support of the user both—through wires which are fixed on a cable fixed to an aluminium ring and passing into this last connecting with a sleeve to the ankles of the legs (see FIG. 2). All the lower part of the harness 305 is in aluminium. The braking bar 300, that acts also as a turning bar, is controlled by means of a coupling with cable 301 from the legs of the user. The coupling with cable 301 is anchored directly to the acceleration bar that is to say to a small cable bent as a lace 302 that connects to a sleeve that joints the ankles, that allows for rendering controllable the control of the rear part of the parachute-paraglider 10 mostly in high wind conditions.

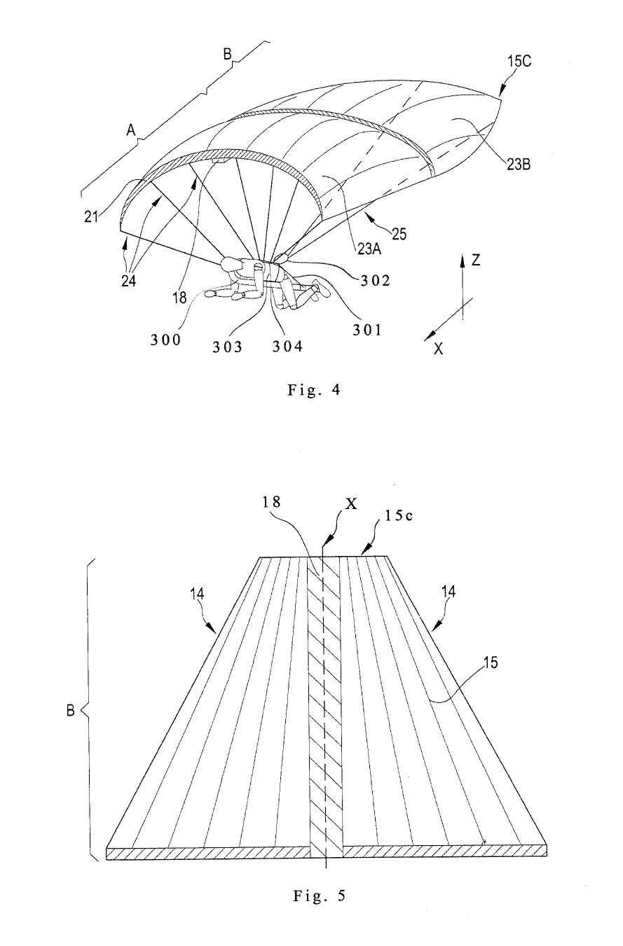

As can be seen in FIG. 4, in the tailed perfected parachute-paraglider which is object of the present invention is therefore present also an harness 303 with a semi-tubular shape suitable for housing the chest of the user, sustaining him. Upwardly a circular element 304 retains it partially open and presents a semi-perimeter of about 43 cm. The harness of the wires represents a band about 40 cm long, and said measure has advantageously been chosen for allowing to enhance the supporting of the chest of the user.

In a preferred and non-limiting embodiment of the present invention, is alternatively present a seat, that is couplet to the bracket as intended in the jargon of the hang-glider of the tailed perfected parachute-paraglider which is object of the present invention. In detail, said tailed perfected parachute-paraglider are structured in such a way that the upper part of the seat can be used as supporting the brake and suitable for controlling the descent and the lift of the rear o queue part of the parachute-paraglider 10, whose bending downwards is guaranted by the pushing of the legs downwards, in detail by a pulling at an height comprised between the calves and the ankles. So acting, a mobility of about 35 cm is guaranted. The advantages of the parachute-paraglider which is object of the present invention are clear in the light of the preceding description. In detail, through the rotational movement of a part of the second portion B respective to the first portion A, obtained on the axis Y, it is possible to obtain a mobile wing effect that allows for an active exercise of the user 100 and an increase of the effect either of gliding or of descent according to the position that the second portion B, through the use of the legs of the user, assumes respective to the position A.

Therefore, the parachute-paraglider which is object of the present invention innovatively combines the effects of a parachute with those of a traditional paraglider.

It is finally clear that to paraglider which is object of the present invention can be applied additions, adaptations and variants obvious for a skilled person without for this departing from the scope of protection provided by the annexed claims.

In particular, it shall be noted that even if in the figures annexed to the present description tailed perfected parachute-paraglider 10 which is object of the present invention can have a very squared shape, it is as well true that the edges thereof can be rounded without losing their function. Said rounding is anyway typical of the traditional paragliders.

1. Tailed improved parachute-paraglider, characterized in that it comprises a first portion (A) with substantially squared/rectangular shape as top view, the front portion respective to an advancement direction F, with sides two by two substantially parallel and opposed and a second portion (B) with trapezoidal shape as top view, the rear portion, comprising a couple of opposite sides of which a first bigger side of said couple of opposite sides coincides to a side of said first portion (A) and a second smaller side of said couple of opposite sides comprising wires suitable for being jointed indirectly to legs and/or feet of a user; the whole or a part of said second portion (B) and eventually whole second portion (B) and part of the first portion (A) from limit-barycentric band to the bigger side of the second portion (B) rotates around an ideal axis (Y), a transversal axis of said improved parachute-paraglider.

2. Tailed improved parachute-paraglider according to claim 1,
characterized in that it comprises at least a bundle of reinforcement radials, a band passing for the centre of mass in a “flat” situation and for a firmer and secure structure during the movement it's recommended adding other four radial bundles or bands: three in the portion A and two in the portion B.

3. Tailed improved parachute-paraglider according to claim 2, characterized in that it comprises a longitudinal beam of reinforcement, arranged in correspondence of a longitudinal axis of said tailed improved parachute-paraglider, and wherein said longitudinal beam extends starting from a front side of the first portion A at the end of said second portion B.

4. Tailed improved parachute-paraglider (441)-according to claim 1, characterized in that it presents a couple of inclined left and right sides of said second portion (B) trapezoidal inclined respective to said longitudinal axis of said tailed improved parachute-paraglider, wherein in correspondence of said inclined left and right sides are present plastic reinforcements of small beams, inclined or transversal bundles in plastic material of helping and sustaining of the sewing of said canopies.

5. Tailed improved parachute-paraglider according to claim 1, characterized in that said first portion (A) presents connecting ropes to a sustaining means of said user, wherein said sustaining means, when said connecting ropes are tightened lies in a point below said first portion (A) laying on a longitudinal axis of said tailed improved parachute-paraglider, and rearward respective to a front side of said first portion (A).

6. Tailed improved parachute-paraglider according to claim 1, wherein at least said first portion (A) and said second portion (B) presents a plurality of canopies and presents arched front section with a variable area.

7. Tailed improved parachute-paraglider according to claim 5, wherein said point wherein lies said sustaining means represents a barycentric point of said tailed improved parachute-paraglider, and wherein said barycentric point moves also in accordance to said rotation of part of the first portion (A) and the second portion (B), the only second portion (B) or part of it respective to the part of first portion (A), the whole first portion (A) and the eventual motionless part of the second portion (B).

8. Tailed improved parachute-paraglider according to claim 1, characterized in that said second portion (B) presents a plurality of transversal bundles in plastics extending substantially parallel or inclined respective to a longitudinal axis (X), being oriented in a direction either substantially longitudinal or inclined with ends directed respectively towards said bigger side and said smaller side.

9. Tailed improved parachute-paraglider according to claim 1, wherein a portion of the terminal portion is higher than the part or the whole of the first portion (A) and than the eventual motionless part of the second portion (B) and where the highest part of the structure is in the smaller side of trapezoidal shape.

10. Tailed improved parachute-paraglider (10) according to claim 1, wherein the band passing the centre of mass in idle condition lies within said first portion (A).
